(19) United States
(12) Patent Application Publication
(10) Pub. No.: US 2026/0156376 A1
(43) Pub. Date: Jun. 4, 2026

(54) Analog to Digital Conversion Method, Image Sensor and Electronic Device

(71) Applicant: HUAWEI TECHNOLOGIES CO., LTD., Shenzhen (CN)

(72) Inventor: Shiroshi Kanemitsu, Tokyo (JP)

(73) Assignee: HUAWEI TECHNOLOGIES CO., LTD., Shenzhen (CN)

(21) Appl. No.: 19/455,322

(22) Filed: Jan. 21, 2026

Related U.S. Application Data
(63) Continuation of application No. PCT/CN2023/117625, filed on Sep. 8, 2023.

(51) Int. Cl. H04N 25/42; H04N 25/78

(52) U.S. Cl. CPC H04N 25/42; H04N 25/78

(57) ABSTRACT

An analog-to-digital conversion method applied to an image sensor having a single-slope analog to digital conversion capability comprises switching between an imaging mode for generating an image frame and a sensing mode for generating a sensing frame, wherein the sensing frame is used to obtain information available when capturing the image frame. The analog-to-digital conversion method further comprises determining, in the imaging mode, each pixel value of the image frame based on comparing a first reference signal having a first stepwise waveform with pixel signals from a plurality of pixels of the image sensor; or determining, in the sensing mode, each pixel value of the sensing frame based on comparing a second reference signal having a second stepwise waveform with the pixel signals, wherein a step width of the second stepwise waveform is larger than that of the first stepwise waveform.

### CROSS-REFERENCE TO RELATED APPLICATION

This is a continuation of International Patent Application No. PCT/CN2023/117625, filed on Sep. 8, 2023, which is incorporated by reference.

### TECHNICAL FIELD

The present disclosure relates to an analog-to-digital conversion method, an image sensor and an electronic device.

### BACKGROUND

An image sensor is equipped with a pixel array formed of multiple photoelectric conversion elements such as photodiodes, and an analog-to-digital converter (ADC) for converting a signal voltage (which may be referred to as a pixel signal) read out from each pixel of the pixel array into a digital value (which may be referred to as a pixel value). An image sensor may employ a single-slope ADC (SS-ADC). The SS-ADC is configured to compare a pixel signal with a reference voltage signal (which may be referred to as a ramp signal) with a stepwise waveform that decreases by a constant voltage width for every unit time, count the number of clocks during a time period in which the pixel signal is larger than the ramp signal, and then output the counted number of clocks as a pixel value.

When outputting a pixel value of q bits (q is a positive integer), that is, when the ADC resolution is q, a ramp signal with 2^{q} steps may be required in the SS-ADC. In some instances, 10-bit to 14-bit ADCs may obtain high-quality images, so that a ramp signal with 2¹⁰ to 2¹⁴ steps may be required in such ADCs. In this case, a counter for counting 2¹⁰ to 2¹⁴ may be required, which causes a problem of longer processing time and larger power consumption of an entire system including the counter.

A two-stage SS-ADC may be used as a method for reducing the number of steps of the ramp signal while suppressing deterioration in image quality. At a first stage, the two-stage SS-ADC obtains, by using a first ramp signal that the number of steps is 2^{q/2}, the number of clocks during a time period in which a pixel signal is larger than the first ramp signal. At a second stage following the first stage, the two-stage SS-ADC obtains, within a voltage range of a step corresponding to the counted number in the first stage, by using a second ramp signal having a step width (that is, a voltage width) that is obtained by equally dividing the step width of the first ramp signal by 2^{q/2} and that the number of steps is 2^{q/2}, the number of clocks during a time period in which the pixel signal is larger than the second ramp signal as a pixel value.

In case of the two-stage SS-ADC, the analog-to-digital (AD) conversion process is divided into two stages, and the ramp signals that the number of steps is 2^{q/2} are used at the two stages respectively, so that the number of counts performed to obtain one pixel value is 2^{q/2}+2^{q/2}. When q≥3, the number of counts can be reduced by employing the two-stage SS-ADC. As mentioned above, challenges for ADCs equipped in image sensors may include how to achieve high image quality while suppressing the number of counts.

However, although high image quality may be required for an image viewed by a user, a high-quality image may not be necessary for sensing processing such as object detection and phase difference detection autofocusing (AF). For example, deep neural networks (e.g., binary neural networks, ternary neural networks, or the like) may detect an object from a low-quality image with sufficient accuracy. Pursuing high image quality increases AD conversion time, which delays start of the sensing processing and delays reflection of a sensing processing result in subsequent imaging operations. For example, such delay may cause a problem such as delay in focusing, which results in inability to capture a subject in time and a missed photo opportunity.

### SUMMARY

Embodiments of the present disclosure relates to an analog to digital conversion method, an image sensor and an electronic device, and provides a solution to resolve an issue mentioned above.

In a first aspect of the present disclosure, an analog to digital conversion method applied to an image sensor having a single-slope analog to digital conversion capability. The method comprising: switching between an imaging mode for generating an image frame and a sensing mode for generating a sensing frame, wherein the sensing frame is used to obtain information available when capturing the image frame; and determining, in the imaging mode, each pixel value of the image frame based on result of comparing a first reference signal having a first stepwise waveform with pixel signals from a plurality of pixels of the image sensor; or determining, in the sensing mode, each pixel value of the sensing frame based on result of comparing a second reference signal having a second stepwise waveform with the pixel signals, wherein a step width of the second stepwise waveform is larger than that of the first stepwise waveform.

According to the first aspect of the present disclosure, in the image sensor having the SS-ADC function, it is possible to switch between the imaging mode for generating an image frame and the sensing mode for generating a sensing frame. In the imaging mode, each pixel value of the image frame is determined based on results of comparison between the first reference signal having the first stepwise waveform and the pixel signals from the plurality of pixels of the image sensor, in other words, AD conversion for the image frame is performed at high ADC resolution. Therefore, high quality image frames are obtained. In the sensing mode, each pixel value of the sensing frame is determined based on results of comparison between the second reference signal having the second stepwise waveform with a larger step width and the pixel signal, in other words, AD conversion for the sensing frame is performed at low ADC resolution. Therefore, the time required for AD conversion is shortened in the sensing mode, which can prevent from delay in starting the sensing processing. As a result, the result of the sensing processing can be utilized in a subsequent imaging operation without significant delay.

In a first possible implementation of the first aspect, the switching between an imaging mode for generating an image frame and a sensing mode for generating a sensing frame is performed for every frame in a video frame sequence. According to the first possible implementation of the first aspect, image frames and sensing frames are acquired alternately, so that the results of the sensing processing that reflect the latest photographing conditions can be utilized for the imaging operations without significant delay.

In a second possible implementation of the first aspect, the determining, in the sensing mode, each pixel value of the sensing frame comprises: determining each pixel value of the sensing frame based on result of comparing pixel signals from pixels in a second area different from a first area including pixels for optical black level adjustments with the second reference signal.

According to the second possible implementation example of the first aspect, in sensing mode, AD conversion of pixel signals from pixels (optical black (OB) pixels) for optical black level adjustments is omitted. Since the OB pixels lack information used for the sensing processing, even if the AD conversion of pixel signals from the OB pixels is omitted, it scarcely affect the results of the sensing processing. In addition, omitting AD conversion for the first area having the OB pixels makes it possible to shorten the time required for the AD conversion in the sensing mode. Further, the number of to-be-processed pixel signals is reduced, so that power consumption of the image sensor is also reduced.

In a third possible implementation of the first aspect, the method further comprises: obtaining and storing an optical black level in the imaging mode; and performing optical black level adjustments to the sensing frame using the stored optical black level.

According to the third possible implementation of the first aspect, the optical black level obtained in the imaging mode is used for the optical black level adjustments to the sensing frame. In the method according to the second possible implementation of the first aspect, an operation for determining pixel values corresponding to the OB pixels is omitted in the sensing mode, so that no optical black level is obtained in the sensing mode. However, in the third possible implementation of the first aspect, the optical black level obtained in the imaging mode is stored, so that the optical black level adjustments to the sensing frame can be performed using the stored optical black level.

In a fourth possible implementation of the first aspect, the determining, in the sensing mode, each pixel value of the sensing frame comprises: determining each pixel value of the sensing frame based on result of comparing pixel signals from a portion of pixels of the image sensor with the second reference signal.

According to the fourth possible implementation of the first aspect, each pixel value of the sensing frame is determined by performing AD conversion on some pixels of the image sensor. For example, some target pixels for AD conversion are determined by binning, cropping and a combination thereof, and the AD conversion is performed on the determined pixels. In this manner, the number of pixels to be subjected to AD conversion in the sensing mode is reduced, so that it is possible to shorten the time required for the AD conversion in the sensing mode, and also reduce power consumption of the image sensor.

In a fifth possible implementation of the first aspect, the determining, in the sensing mode, each pixel value of the sensing frame comprises: obtaining a reset value corresponding to a reset component of said each pixel signal of the sensing frame, using the first reference signal; and determining, using the second reference signal and based on the reset value, a signal value corresponding to a remaining component after eliminating the reset component from said each pixel signal of the sensing frame, as a pixel value corresponding to said each pixel signal of the sensing frame.

According to the fifth possible implementation of the first aspect, the reset value corresponding to the reset component of the pixel signal is obtained with high ADC resolution, and the signal value corresponding to the signal component of the pixel signal is obtained with low ADC resolution. Since the reset component of the pixel signal is smaller than the signal component of the pixel signal, the reset value can be obtained in a short time even with high ADC resolution. In this way, the signal component can be extracted with high precision by obtaining the reset value with high ADC resolution.

In a sixth possible implementation of the first aspect, the determining, in the sensing mode, each pixel value of the sensing frame comprises: obtaining a reset value corresponding to a reset component of said each pixel signal of the sensing frame, using the second reference signal; and determining, using the second reference signal and based on the reset value, a signal value corresponding to a remaining component after eliminating the reset component from said each pixel signal of the sensing frame, as a pixel value corresponding to said each pixel signal of the sensing frame.

According to the sixth possible implementation of the first aspect, both the reset value corresponding to the reset component of the pixel signal and the signal value corresponding to the signal component of the pixel signal are obtained at low ADC resolution. When the reset component of the pixel signal is sufficiently small or the reset component scarcely affects the result of the sensing processing, the method according to the sixth possible implementation of the first aspect makes it possible to shorten the time required for AD conversion in the sensing mode and also reduce power consumption of the image sensor.

In a seventh possible implementation of the first aspect, the determining, in the imaging mode, each pixel value of the imaging frame comprises: obtaining a reset value corresponding to a reset component of said each pixel signal of the sensing frame, using the first reference signal; determining, using the second reference signal and based on the reset value, a first signal value corresponding to a remaining component after eliminating the reset component from said each pixel signal of the sensing frame; and determining, using the first reference signal and within a preset value range including the first signal value, a second signal value corresponding to the remaining component as a pixel value corresponding to said each pixel signal of the sensing frame, wherein the second signal value has a higher precision than the first signal value.

According to the seventh possible implementation of the first aspect, in the imaging mode, when determining the signal value corresponding to the signal component of the pixel signal, at a first stage, an operation of determining the first signal value at low ADC resolution is performed, and at a second stage, an operation of determining the second signal value at high ADC resolution is performed within a value range including the first signal value. In this way, a processing load and power consumption of the image sensor can be reduced by employing the two-stage SS-ADC manner in the imaging mode.

In a second aspect of the present disclosure, an image sensor having a single-slope analog to digital conversion capability is provided. The image sensor comprises: a timing controller configured to switch between an imaging mode for generating an image frame and a sensing mode for generating a sensing frame, wherein the sensing frame is used to obtain information available when capturing the image frame; a reference signal generator configured to generate a first reference signal having a first stepwise waveform and a second reference signal having a second stepwise waveform, wherein a step width of the second stepwise waveform is larger than that of the first stepwise waveform; and a converting section, or converter, configured to determine, in the imaging mode, each pixel value of the image frame based on result of comparing the first reference signal with pixel signals from a plurality of pixels of the image sensor; or determine, in the sensing mode, each pixel value of the sensing frame based on result of comparing the second reference signal with the pixel signals.

According to the second aspect of the present disclosure, in the image sensor having the SS-ADC function, it is possible to switch between the imaging mode for generating the image frame and the sensing mode for generating the sensing frame. In the imaging mode, each pixel value of the image frame is determined based on results of comparison between the first reference signal having the first stepwise waveform and the pixel signals from the plurality of pixels of the image sensor, in other words, AD conversion for the image frame is performed at high ADC resolution. Therefore, high quality image frames are obtained. In the sensing mode, each pixel value of the sensing frame is determined based on results of comparison between the second reference signal having the second stepwise waveform with a larger step width and the pixel signal, in other words, AD conversion for the sensing frame is performed at low ADC resolution. Therefore, the time required for AD conversion is shortened in the sensing mode, which can prevent from delay in starting the sensing processing. As a result, the result of the sensing processing can be utilized in a subsequent imaging operation without significant delay.

In a first possible implementation of the second aspect, the timing controller is further configured to switch between the imaging mode and the sensing mode for every frame in a video frame sequence. According to the first possible implementation of the second aspect, image frames and sensing frames are acquired alternately, so that the results of the sensing processing that reflect the latest photographing conditions can be utilized for the imaging operations without significant delay.

In a second possible implementation of the second aspect, the converting section is further configured to determine each pixel value of the sensing frame based on result of comparing pixel signals from pixels in a second area different from a first area including pixels for optical black level adjustments with the second reference signal.

According to the second possible implementation of the second aspect, in sensing mode, AD conversion of pixel signals from pixels (OB pixels) for optical black level adjustments is omitted. Since the OB pixels lack useful information for the sensing processing, even if the AD conversion of pixel signals from the OB pixels is omitted, it scarcely affects the results of the sensing processing. In addition, omitting the AD conversion for the first area having the OB pixels makes it possible to shorten the time required for the AD conversion in the sensing mode. Further, the number of to-be-processed pixel signals is reduced, so that power consumption of the image sensor is also reduced.

In a third possible implementation of the second aspect, the image sensor further comprises: a processor configured to obtain and store an optical black level in the imaging mode, and perform optical black level adjustments to the sensing frame using the stored optical black level.

According to the third possible implementation of the second aspect, the optical black level obtained in the imaging mode is used for the optical black level adjustments to the sensing frame. Since the image sensor according to the second possible implementation of the second aspect omits an operation for determining pixel values corresponding to the OB pixels in the sensing mode, no optical black level is obtained in the sensing mode. However, in the third possible implementation of the first aspect, the optical black level obtained in the imaging mode is stored, so that the optical black level adjustments to the sensing frame can be performed using the stored optical black level.

In a fourth possible implementation of the second aspect, the converting section is further configured to determine each pixel value of the sensing frame based on result of comparing pixel signals from a portion of pixels of the image sensor with the second reference signal.

According to the fourth possible implementation of the second aspect, each pixel value of the sensing frame is determined by performing AD conversion on some pixels of the image sensor. For example, some target pixels for AD conversion are determined by binning, cropping and a combination thereof, and the AD conversion is performed on the determined pixels. In this way, the number of pixels to be subjected to AD conversion in the sensing mode is reduced, so that it is possible to shorten the time required for the AD conversion in the sensing mode, and also reduce power consumption of the image sensor.

In a fifth possible implementation of the second aspect, when determining, in the sensing mode, each pixel value of the sensing frame, the converting section is further configured to: obtain a reset value corresponding to a reset component of said each pixel signal of the sensing frame, using the first reference signal; and determine, using the second reference signal and based on the reset value, a signal value corresponding to a remaining component after eliminating the reset component from said each pixel signal of the sensing frame, as a pixel value corresponding to said each pixel signal of the sensing frame.

According to the fifth possible implementation of the second aspect, the reset value corresponding to the reset component of the pixel signal is obtained with high ADC resolution, and the signal value corresponding to the signal component of the pixel signal is obtained with low ADC resolution. Since the reset component of the pixel signal is smaller than the signal component of the pixel signal, the reset value can be obtained in a short time even with high ADC resolution. In this way, the signal component can be extracted with high precision by obtaining the reset value with high ADC resolution.

In a sixth possible implementation of the second aspect, when determining, in the sensing mode, each pixel value of the sensing frame, the converting section is further configured to: obtain a reset value corresponding to a reset component of said each pixel signal of the sensing frame, using the second reference signal; and determine, using the second reference signal and based on the reset value, a signal value corresponding to a remaining component after eliminating the reset component from said each pixel signal of the sensing frame, as a pixel value corresponding to said each pixel signal of the sensing frame.

According to the sixth possible implementation of the second aspect, both the reset value corresponding to the reset component of the pixel signal and the signal value corresponding to the signal component of the pixel signal are obtained at low ADC resolution. When the reset component of the pixel signal is sufficiently small or the reset component scarcely affects the result of the sensing processing, applying configuration of the sixth possible implementation of the second aspect to the image sensor makes it possible to shorten the time required for AD conversion in the sensing mode and also reduce power consumption of the image sensor.

In a seventh possible implementation of the second aspect, when determining, in the imaging mode, each pixel value of the imaging frame, the converting section is further configured to: obtain a reset value corresponding to a reset component of said each pixel signal of the sensing frame, using the first reference signal; determine, using the second reference signal and based on the reset value, a first signal value corresponding to a remaining component after eliminating the reset component from said each pixel signal of the sensing frame; and determine, using the first reference signal and within a preset value range including the first signal value, a second signal value corresponding to the remaining component as a pixel value corresponding to said each pixel signal of the sensing frame, wherein the second signal value has a higher precision than the first signal value.

According to the seventh possible implementation of the second aspect, in the imaging mode, when determining the signal value corresponding to the signal component of the pixel signal, at a first stage, an operation of determining the first signal value at low ADC resolution is performed, and at a second stage, an operation of determining the second signal value at high ADC resolution is performed within a value range including the first signal value. In this way, a processing load and power consumption of the image sensor can be reduced by employing the two-stage SS-ADC manner in the imaging mode.

In a third aspect of the present disclosure, an electronic device equipped with the image sensor according to the second aspect or any one of the first to seventh possible implementations of the second aspect is provided. For technical effects caused from the third aspect, refer to description of technical effects caused from the second aspect or any one of the first to seventh possible implementations of the second aspect. Details are not described herein again.

### BRIEF DESCRIPTION OF DRAWINGS

FIG. 1 is a schematic diagram for describing sensing frames.

FIG. 2 is a schematic diagram showing an exemplary structure of an imaging module according to a first embodiment of the present disclosure.

FIG. 3 is a timing chart for describing a fine AD conversion.

FIG. 4 is a timing chart for describing a coarse AD conversion according to the first embodiment of the present disclosure.

FIG. 5 is a schematic diagram for describing a ramp waveform used for the coarse ADC and a ramp waveform used for the fine ADC.

FIG. 6 is a schematic diagram showing an example of a reference voltage generator.

FIG. 7 is a timing chart for describing an exemplary implementation in which the coarse ADC is applied to a reset component of a pixel signal.

FIG. 8 is a diagram for describing another exemplary structure of a converting section.

FIG. 9 is a timing chart for describing operation of the converting section shown in FIG. 8, in the sensing mode.

FIG. 10 is a timing chart for describing operation of the converting section shown in FIG. 8, in the imaging mode.

FIG. 11 is a schematic diagram for describing an exemplary implementation in which binning and/or cropping are/is applied to the coarse ADC.

FIG. 12 is a schematic diagram showing an exemplary structure of an imaging module according to the second embodiment of the present disclosure.

FIG. 13 is a schematic diagram for describing a two-stage SS-ADC manner.

FIG. 14 is a timing chart for describing an AD conversion process in the two-stage SS-ADC manner, in the imaging mode.

FIG. 15 is a schematic diagram for describing an exemplary implementation in which asynchronous ripple counters are used for the converting section.

FIG. 16 is a schematic diagram showing an exemplary circuit configuration of an asynchronous ripple counter.

FIG. 17 is a timing chart for describing operation of the converting section shown in FIG. 15.

FIG. 18 is a timing chart for describing an exemplary implementation in which the two-stage SS-ADC manner is applied to AD conversion of a reset component of the pixel signal.

FIG. 19 is a block diagram illustrating an example of an electronic device that may be equipped with the imaging module of the present disclosure.

FIG. 20 is a flow chart showing an exemplary procedure of AD conversion by the imaging module of the present disclosure.

FIG. 21 is a flow chart showing an exemplary procedure of optical black level adjustments by the imaging module of the present disclosure.

### DETAILED DESCRIPTION

The following describes the technical solutions in embodiments of this disclosure with reference to the accompanying drawings in embodiments of this disclosure.

It should be noted that in the following description, “at least one” means one or more and “a plurality of” means two or more. In addition, “and/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, at least one of a, b, and c may represent: a, b, c, a and b, a and c, b and c, or a, b, and c, where a, b, and c each may be singular or plural.

### 1. First Embodiment

The following describes a first embodiment of the present disclosure. The first embodiment of the present disclosure relates to an AD conversion method and an image sensor, in particular, relates to an imaging module that is equipped with an image sensor having a single-slope analog to digital conversion capability. The imaging module according to the first embodiment has a function of switching between an imaging mode for generating an image frame and a sensing mode for generating a sensing frame used for sensing processing. The imaging module is configured to perform AD conversion at high ADC resolution in imaging mode and perform AD conversion at low ADC resolution in sensing mode. The AD conversion at high ADC resolution may be referred to as a fine ADC, and the AD conversion at low ADC resolution may be referred to as a coarse ADC.

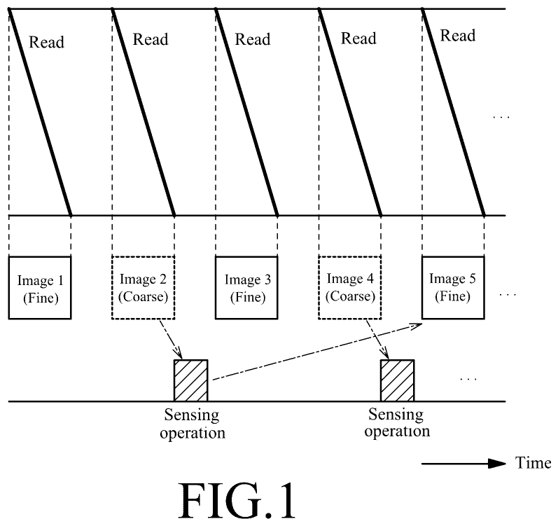

For example, when shooting a video made of a frame sequence, the imaging module generates the first frame (Image 1) in the imaging mode, and then switches from the imaging mode to the sensing mode, as shown in FIG. 1. Then, the imaging module generates the second frame (Image 2) in the sensing mode, and then switches from the sensing mode to the imaging mode. In this case, the second frame is a sensing frame used for the sensing processing.

After the sensing frame is generated, the sensing processing is performed based on the generated sensing frame. For example, object detection is performed to detect one or more objects (such as person's faces) based on the sensing frame. Charge accumulation in each pixel of the image sensor starts before the sensing processing is completed, so that result of the sensing processing is used when capturing an image frame (Image 5 in the example of FIG. 1) after the third frame (Image 3). For example, it is possible to automatically capture and focus on the objects using result of the sensing processing.

In the sensing mode, the imaging module according to the first embodiment generates the sensing frame based on the coarse ADC. Therefore, the sensing frame can be generated in a short time, so that result of the sensing processing is obtained quickly. In the example of FIG. 1, the result of the sensing processing may be utilized for an imaging operation of the closest image frame (Image 5) to a corresponding sensing frame, among image frames after the third frame (Image 3). In this way, delay in sensing processing can be prevented by introducing the sensing mode, so that a problem such as missing a shutter chance due to delay in capturing the subject hardly occurs. Further, a processing load and power consumption are reduced. For ease of description, an example of video shooting has been given, but similar technical effects may be obtained in a case that a plurality of still images are shot continuously.

### Configuration of the Imaging Module

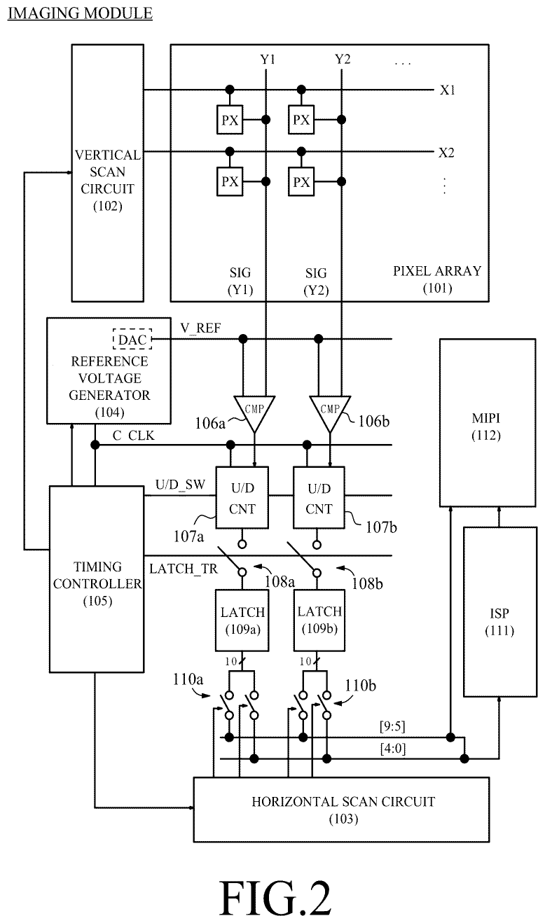

With reference to FIG. 2, the following further describes the imaging module according to the first embodiment of the present disclosure. As shown in FIG. 2, the imaging module according to the first embodiment includes a pixel array 101, a vertical scan circuit 102, a horizontal scan circuit 103, a reference voltage generator 104 and a timing controller 105.

The imaging module according to the first embodiment further includes comparators (CMPs) 106a and 106b, up/down (U/D) counters (U/D CNT) 107a and 107b, switches 108a and 108b, latch circuits (LATCH) 109a and 109b, and switch pairs 110a and 110b.

The imaging module according to the first embodiment further includes an image signal processor (ISP) 111 and a mobile industry processor interface (MIPI) 112.

The entire imaging module shown in FIG. 2 may be referred to as “image sensor”, or a remaining portion of the imaging module excluding the ISP 111 may be referred to as “image sensor”. In this specification, a section including the comparators 106a and 106b, the U/D counters 107a and 107b, the switches 108a and 108b, the latch circuits 109a and 109b, and the switch pairs 110a and 110b may be referred to as “converting section”.

As shown in FIG. 2, the pixel array 101 includes a plurality of pixels (PX) each formed by a photoelectric conversion element such as a photodiode, and each pixel is arranged at a position where one of horizontal signal lines X1, X2, . . . , Xn (n is a positive integer) and one of vertical signal lines Y1, Y2, . . . , Ym (m is a positive integer) intersect. In FIG. 2, the horizontal signal lines X3, . . . , Xn and the vertical signal lines Y3, . . . , Ym are omitted for simplicity. Further, comparators, U/D counters, switches, latch circuits and switch pairs corresponding to the vertical signal lines Y3, . . . , Ym are also omitted for simplicity. It should be understood that the components corresponding to the vertical signal lines Y1, . . . , Ym have substantially the same configuration as each other. Thus, the following may focus on components corresponding to the vertical signal lines Y1 and Y2, and description of components corresponding to the vertical signal lines Y3, . . . , Ym may be omitted for ease of description. For the components corresponding to the vertical signal lines Y3, . . . , Ym, refer to description of the components corresponding to the vertical signal lines Y1 and Y2.

The vertical scan circuit 102 is configured to sequentially transmit instructions via the horizontal signal lines X1, X2, . . . Xn to instruct readout of charges (pixel signals) accumulated in corresponding pixels. The pixel signals read from pixels connected with the vertical signal lines Y1 and Y2 are transmitted to the comparators 106a and 106b via the vertical signal lines Y1 and Y2 respectively. For ease of description, the pixel signal transmitted via the i-th vertical signal line Yi may be denoted as SIG(Yi) herein.

The vertical signal line Y1 is connected to one input terminal of the comparator 106a, and the pixel signal SIG(Y1) is input to the one input terminal of the comparator 106a. A reference voltage signal V_REF supplied from the reference voltage generator 104 is input to the other input terminal of the comparator 106a. Similarly, the vertical signal line Y2 is connected to one input terminal of the comparator 106b, and the pixel signal SIG(Y2) is input to the one input terminal of the comparator 106b. The reference voltage signal V_REF supplied from the reference voltage generator 104 is input to the other input terminal of the comparator 106b. It should be noted that connection relationships and operations of the components corresponding to the vertical signal lines Y3, . . . , Ym are substantially the same as those of the components corresponding to the vertical signal lines Y1 and Y2. Therefore, redundant description is omitted herein.

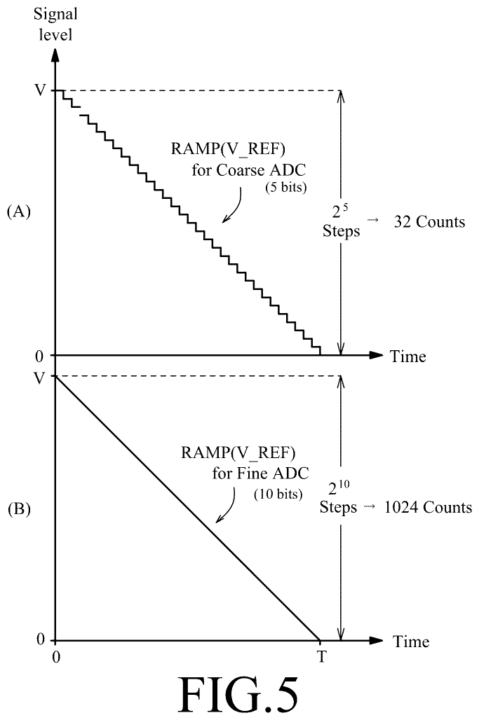

The reference voltage generator 104 has a digital-to-analog converter (DAC) that generates the reference voltage signal V_REF used for AD conversion. The reference voltage signal V_REF has a stepped ramp waveform (stepwise waveform) that decreases by a constant voltage width per unit time. In the first embodiment of the present disclosure, the reference voltage generator 104 generates two types of the reference voltage signal V_REF: a first reference signal (e.g., ramp waveform (A) in FIG. 5) used for the fine ADC and a second reference signal (e.g., ramp waveform (B) in FIG. 5) used for the coarse ADC.

As shown in FIG. 5, the first reference signal and the second reference signal have ramp waveforms that monotonically decrease from a preset voltage V (V>0) to a voltage 0 during a preset time period T. The second reference signal has a larger step width (that is, a magnitude of a voltage that decreases in one step) than the first reference signal, so that the second reference signal has fewer steps than the first reference signal.

When ADC resolution is 5 bits, the number of steps in the ramp waveform is 2⁵ (=32), and when the ADC resolution is 10 bits, the number of steps in the ramp waveform is 2¹⁰ (=1024). The number of steps in the reference voltage signal V_REF corresponds to the number of counts by the counter connected to the comparator, and the greater number of counts causes longer processing time. In this example, the number of counts in the coarse ADC is reduced to 1/32 of the number of counts in the fine ADC, so that the processing time required to generate the sensing frame can be reduced. Since the number of operations of the counter is reduced, power consumption required to generate the sensing frame can also be reduced.

The reference voltage signal V_REF is generated based on a clock signal C_CLK supplied from the timing controller 105 to the reference voltage generator 104. A falling edge of each step of the reference voltage signal V_REF is synchronized with a falling edge of a corresponding pulse of the clock signal C_CLK. Therefore, a length of a flat portion of each step of the reference voltage signal V_REF matches one pulse width of the clock signal C_CLK. Two types of the clock signal C_CLK are used to generate the first reference signal and the second reference signal. One clock signal C_CLK having a pulse width PW1 for the fine ADC is used to generate the first reference signal, and another clock signal C_CLK having a pulse width PW2 (PW2>PW1) for the coarse ADC is used to generate the second reference signal.

Timing for switching between the imaging mode and the sensing mode is informed from the timing controller 105 to the reference voltage generator 104. The timing controller 105 switches an operation mode from the imaging mode to the sensing mode or from the sensing mode to the imaging mode in frame units. In the example of FIG. 1, the timing controller 105 switches between the imaging mode and the sensing mode for every frame. Optionally, the timing controller 105 may switch the operating mode such that one frame among consecutive f frames (f≥3) is the sensing frame and the remaining (f−1) frames are the image frames.

Refer to FIG. 2 again. When one input terminal of the comparator 106a receives the pixel signal SIG(Y1) and the other input terminal of the comparator 106a receives the reference voltage signal V_REF, the comparator 106a compares the pixel signal SIG(Y1) with the reference voltage signal V_REF. When the pixel signal SIG (Y1) is larger than the reference voltage signal V_REF, the comparator 106a outputs an output signal CMP_OUT with High level. When the pixel signal SIG (Y1) is smaller than the reference voltage signal V_REF, the comparator 106a outputs the output signal CMP_OUT with Low level (e.g., 0). An output terminal of the comparator 106a is connected to the U/D counter 107a, and the output signal CMP_OUT is supplied to the U/D counter 107a.

The U/D counter 107a is a counter having an up-count mode and a down-count mode. The clock signal C_CLK from the timing controller 105 is input to a clock input terminal of the U/D counter 107a. In the up-count mode, a value of the U/D counter 107a is incremented by 1 at rising timing of the clock signal C_CLK when the output signal CMP_OUT is at High level. In the down-count mode, a value of the U/D counter 107a is decremented by 1 at rising timing of the clock signal C_CLK when the output signal CMP_OUT is at Low level. Switching between the up-count mode and the down-count mode is performed according to a switching signal U/D_SW from the timing controller 105.

In the first embodiment of the present disclosure, the down-count mode is used when reading out the reset component of the pixel signal, and the up-count mode is used when reading out the signal component of the pixel signal. The reset component is an offset component such as noise that varies from pixel to pixel.

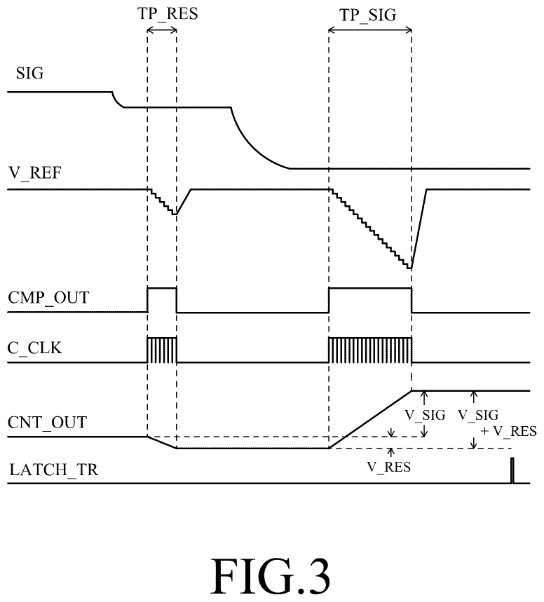

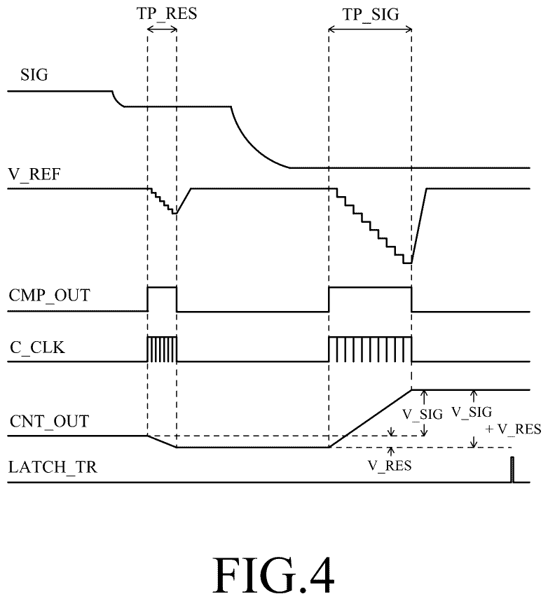

As shown in FIG. 3 and FIG. 4, the timing controller 105 controls the vertical scan circuit 102 to read out the reset component during a time period TP_RES for reading out the reset component. During the time period TP_RES, the reference voltage signal V_REF and the clock signal C_CLK are supplied to the comparator 106a, and the output signal CMP_OUT from the comparator 106a is input to the U/D counter 107a. In this case, the U/D counter 107a is set to the down-count mode, and when the output signal CMP_OUT is at High level, the counter value CNT_OUT is decremented by 1 at rise timing of the clock signal C_CLK. Since an initial value of the U/D counter 107a is set to 0, a value V_RES corresponding to the reset component of the pixel signal is a negative value.

The timing controller 105 controls the vertical scan circuit 102 to read out the signal components during a time period TP_SIG for reading out the signal component. During the time period TP_SIG, the reference voltage signal V_REF and the clock signal C_CLK are supplied to the comparator 106a, and the output signal CMP_OUT from the comparator 106a is input to the U/D counter 107a. In this case, the U/D counter 107a is set to up-count mode, and when the output signal CMP_OUT is at a high level, the counter value CNT_OUT is incremented by 1 at rising timing of the clock signal C_CLK. Since the counter value is incremented from the value V_RES (V_RES<0) corresponding to the reset component, the reset component is substantially removed from the counter value, and the value V_SIG (pixel value) corresponding only to the signal component is obtained eventually.

Operations of the comparator 106b and the U/D counter 107b are substantially the same as those of the comparator 106a and the U/D counter 107a described above.

The timing controller 105 controls the switches 108a and 108b to be a connected state via a transfer instruction signal LATCH_TR that indicates timing when the U/D counters 107a and 107b have obtained counter values for one pixel (that is, timing when AD conversion duration for one pixel is terminated), to store the counter values (pixel values) in the latch circuits 109a and 109b respectively.

In the first embodiment of the present disclosure, output terminals of the latch circuits 109a and 109b are connected to a first output signal line for outputting upper bits of the pixel values and a second output signal line for outputting lower bits of the pixel values via the switch pairs 110a and 110b respectively. Each of the switch pairs 110a and 110b includes a first switch connected to the first output signal line and a second switch connected to the second output signal line. In the figure, each of the first output signal line and the second output signal line is shown as one solid line, but it should be noted that each of these output signal lines is a signal line set including multiple signal lines, and the number of signal lines in the signal line set corresponds to the number of readout bits.

The horizontal scan circuit 103 controls the switch pairs 110a and 110b to read out the pixel values from the latch circuits 109a and 109b. At this time, the horizontal scan circuit 103 may individually control the first switch and the second switch to independently control readout timing of the upper bits and readout timing of the lower bits. For example, in the imaging mode, the horizontal scan circuit 103 controls the first switch and the second switch to be the connected state, to output the upper bits through the first output signal line and the lower bits through the second output signal line. In the sensing mode, the horizontal scan circuit 103 controls only the first switch to be the connected state, to output the upper bits through the first output signal line. In the sensing mode, the second output signal line for the lower bits is not used for readout, so that power consumption is reduced.

As mentioned above, in the first embodiment of the present disclosure, the fine ADC is performed in the imaging mode, and the coarse ADC is performed in the sensing mode. In the fine ADC, the first reference signal having a stepwise waveform like the ramp waveform (B) shown in FIG. 5 is used as the reference voltage signal V_REF. In the coarse ADC, the second reference signal having a stepwise waveform such as the ramp waveform (A) shown in FIG. 5 is used as the reference voltage signal V_REF.

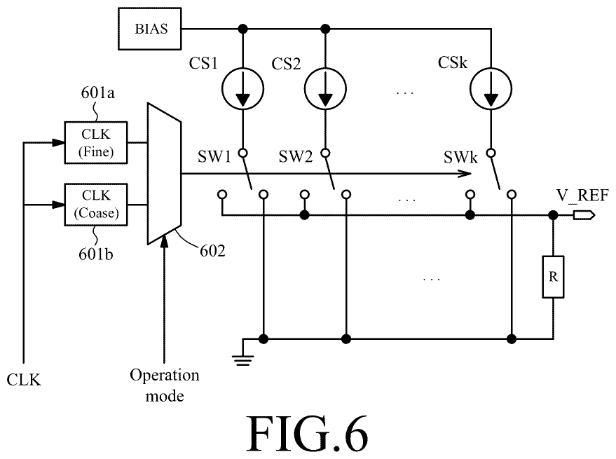

These two types of ramp waveforms may be generated using exemplary circuit configuration of a digital-to-analog converter (DAC) shown in FIG. 6. CLK 601a indicates a generator of the clock signal C_CLK with the pulse width PW1 for the fine ADC, and CLK 601b indicates a generator of the clock signal C_CLK with the pulse width PW2 for the coarse ADC. A selector 602 outputs the clock signal C_CLK from the CLK 601a when the operation mode is the imaging mode, and outputs the clock signal C_CLK from the CLK 601b when the operation mode is the sensing mode.

The DAC shown in FIG. 6 includes constant voltage sources CS1, CS2, . . . , CSk that supply the same constant voltage, and switches SW1, SW2, . . . , SWk. The switches SW1, SW2, . . . , SWk are switched to a connected state in turn at rise timing of the clock signal C_CLK. As a result, an output voltage is reduced stepwise at rising timing of the clock signal C_CLK, and the reference voltage signal V_REF synchronized with the clock signal C_CLK shown in FIG. 3 or FIG. 4 is obtained.

FIG. 3 is a timing chart corresponding to a fine ADC. In the fine ADC, as shown in FIG. 3, in the time period TP_RES for reading out the reset component, the value V_RES corresponding to the reset component is read out, and in the time period TP_SIG for reading out the signal component, the value V_SIG corresponding to the signal component is read out as a pixel value. In the fine ADC, the first reference signal is used as the reference voltage signal V_REF during the time period TP_SIG for reading out the signal component, and the clock signal C_CLK with a smaller pulse width (PW1) is used. In this way, a high-quality image frame can be generated using the fine ADC. In the imaging mode, the horizontal scan circuit 103 controls both the first switch and the second switch of each switch pair to be the connected state, to read out the entire pixel value, that is, both the upper bits and the lower bits of the pixel value.

FIG. 4 is a timing chart corresponding to the coarse ADC. In the coarse ADC, as shown in FIG. 4, in the time period TP_RES for reading out the reset component, the value V_RES corresponding to the reset component is read out, and in the time period TP_SIG for reading out the signal component, the value V_SIG corresponding to the signal component is read out as a pixel value. In the coarse ADC, the second reference signal is used as the reference voltage signal V_REF in the time period TP_SIG for reading out the signal component, and the clock signal C_CLK with a larger pulse width (PW2) is used. This reduce the number of counts, so that the sensing frame is generated in a shorter time. In the sensing mode, the horizontal scan circuit 103 controls only the first switch of each switch pair to be the connected state to read out the upper bits of the pixel value.

In the imaging mode, the pixel value read out from each latch circuit is input to the ISP 111. In other words, image data of the image frame is input to the ISP 111. The ISP 111 may perform processing such as optical black level adjustments, high dynamic range (HDR), gain adjustments, white balance adjustments, shading correction, demosaicing, color correction, gamma correction and sharpness. Optionally, result of object recognition using artificial intelligence (AI) may be utilized for the processing by the ISP 111. Further, AI functionality may be incorporated into the ISP 111. The image frame processed by the ISP 111 is output to the outside of the imaging module via the MIPI 112. In the sensing mode, the pixel value read out from each latch circuit is output to the outside of the imaging module via the MIPI 112. In other words, image data of the sensing frame are output to the outside of the imaging module.

As described above, the imaging module according to the first embodiment of the present disclosure switches between the imaging mode and the sensing mode in frame units. In the imaging mode, the imaging module performs the fine ADC to generate the high-quality image frame. In the sensing mode, the imaging module performs the coarse ADC to generate the sensing frame in a shorter time. This prevents delay in the sensing processing, and makes it possible to utilize result of the sensing processing in operations for imaging a subsequent image frame in a timely manner. In addition, processing load in the sensing mode is reduced, so that power consumption is also suppressed.

### Exemplary Implementation 1A

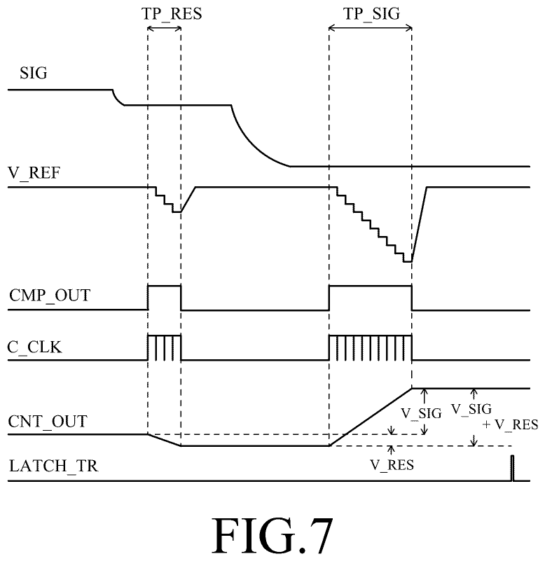

The following describes exemplary implementation 1A according to the first embodiment of the present disclosure with reference to FIG. 7.

In the example shown in FIG. 4, the first reference signal is used as the reference voltage signal V_REF during the time period TP_RES for reading out the reset component. When the reset component is sufficiently small compared to the signal component and the reset component scarcely affects result of the sensing processing, it is possible to apply the coarse ADC to operations in the time period TP_RES for reading out the reset component, as shown in FIG. 7. The exemplary implementation 1A proposes a method of performing the coarse ADC during the time period TP_RES for reading out the reset component.

In imaging mode, the imaging module performs operations described with reference to FIG. 3. On the other hand, in the sensing mode, the timing controller 105 generates the clock signal C_CLK having the pulse width PW2 for the coarse ADC during both the time period TP_RES for reading out the reset component and the time period TP_SIG for reading out the signal component, and then supplies the clock signal C_CLK to the voltage generator 104 and U/D counters 107a and 107b. The reference voltage generator 104 generates the second reference signal for the coarse ADC during both the time period TP_RES for reading out the reset component and the time period TP_SIG for reading out the signal component, and then supplies the second reference signal to the comparators 106a and 106b. Except for operations described with reference to FIG. 7, operations of each component of the imaging module according to the exemplary implementation 1A is the same as operations of each component already described above. Therefore, redundant description is omitted herein.

### Exemplary Implementation 1B

The following describes exemplary implementation 1B according to the first embodiment of the present disclosure with reference to FIG. 7 to FIG. 10.

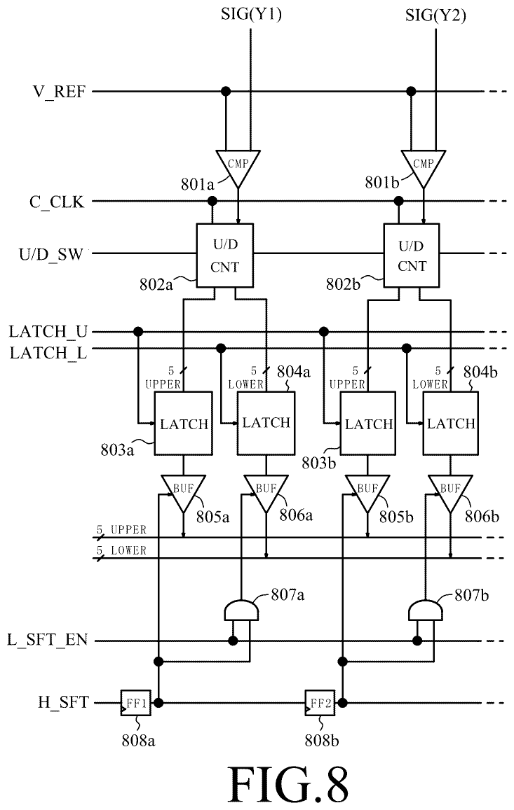

In the example of FIG. 2, each of the latch circuits 109a and 109b stores all bits of a corresponding pixel value, and the upper bits and the lower bits of the pixel value are individually read out using the switch pair 110a and 110b. In the exemplary implementation 1B, as circuit configuration shown in FIG. 8, a latch circuit corresponding to the upper bits and a latch circuit corresponding to the lower bits are provided separately. In the circuit configuration proposed in the exemplary implementation 1B, the upper bits and lower bits are read out using a shift register enable signal L_SFT_EN for lower bits and a shift register signal H_SFT for horizontal reading.

In FIG. 8, components corresponding to the converting section of the imaging module are illustrated. For simplicity of description, similar to the example of FIG. 2, components corresponding to the vertical signal lines Y3, . . . , Ym are omitted. Functionality and operations of comparators 801a and 801b shown in FIG. 8 are substantially the same as those of the comparators 106a and 106b shown in FIG. 2. Functionality of U/D counters 802a and 802b shown in FIG. 8 are substantially the same as the U/D counters 107a and 107b shown in FIG. 2. The same applies to components corresponding to the vertical signal lines Y3, . . . , Ym.

Upper bits of an output signal CNT_OUT from the U/D counter 802a (that is, upper bits of the pixel value) are supplied to the latch circuit 803a. A timing signal LATCH_U for the upper bits is supplied from the timing controller 105 to the latch circuit 803a. The timing signal LATCH_U indicates timing when AD conversion duration for one pixel is terminated, that is, timing when AD conversion for a pixel signal read out from one pixel is completed. The latch circuit 803a latches the upper bits of the pixel value from the U/D counter 802a at rising timing of the timing signal LATCH_U, and outputs the upper bits to the buffer 805a.

An output signal FF1_OUT from a first-stage flip-flop (FF1) 808a is supplied as a control signal to the buffer 805a. A shift register signal H_SFT for horizontal reading is input to the FF1. The buffer 805a outputs the upper bits of the pixel value stored therein to the first output signal line for the upper bits at rising timing of the output signal FF1_OUT from the FF1.

Lower bits of the output signal CNT_OUT from the U/D counter 802a (that is, lower bits of the pixel value) are supplied to the latch circuit 804a. A timing signal LATCH_L for the lower bits is supplied from the timing controller 105 to the latch circuit 804a. The timing signal LATCH_L indicates timing when AD conversion duration for one pixel is terminated, that is, timing when AD conversion for a pixel signal read out from one pixel is completed. The latch circuit 804a latches the lower bits of the pixel value from the U/D counter 802a at rising timing of the timing signal LATCH_L, and outputs the lower bits to the buffer 806a.

The buffer 806a is supplied with result of an AND operation between the output signal FF1_OUT from the first stage flip-flop (FF1) 808a and the shift register enable signal L_SFT_EN for the lower bits (that is, an output signal from an AND circuit 807a) as a control signal. The buffer 806a supplies the lower bits of the pixel value stored therein to the second output signal line for the lower bits at rising timing of the output signal from the AND circuit 807a.

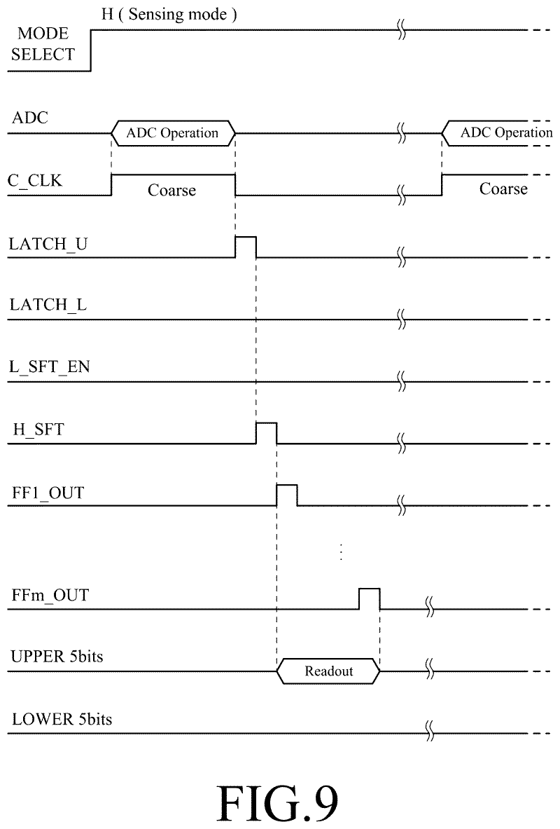

Operation timing in the sensing mode is as shown in FIG. 9. As shown in FIG. 9, in the sensing mode, when AD conversion is started, the timing controller 105 generates the clock signal C_CLK for the coarse ADC, and the reference voltage generator 104 generates the second reference signal. Then, the converting section performs the coarse ADC based on the clock signal C_CLK and the second reference signal.

The timing signal LATCH_U for the upper bits rises at timing when AD conversion duration for one pixel is terminated, that is, timing when AD conversion for a pixel signal read out from one pixel is completed, and the upper bits are read out from the U/D counter 802a and latched by the latch circuit 803a.

Since no lower bit is generated in the coarse ADC, the timing signal LATCH_L for the lower bits is not supplied to the latch circuit 804a, that is, LATCH_L remains at Low level. Since the shift register enable signal L_SFT_EN for the lower bits is also not supplied to the AND circuit 807a, reading out from the buffer 806a is omitted.

The shift register signal H_SFT for horizontal reading rises at falling timing of the timing signal LATCH_U for the upper bits. The output signal FF1_OUT from the FF1 rises at falling timing of the shift register signal H_SFT. The upper bits are read out from the buffer 805a in response to rising of the output signal FF1_OUT from the FF1. Similarly, the upper bits are sequentially read out from corresponding buffers other than the buffer 805a in response to rising of the output signals FF2_OUT, . . . , FFm_OUT from FF2, . . . , FFm respectively.

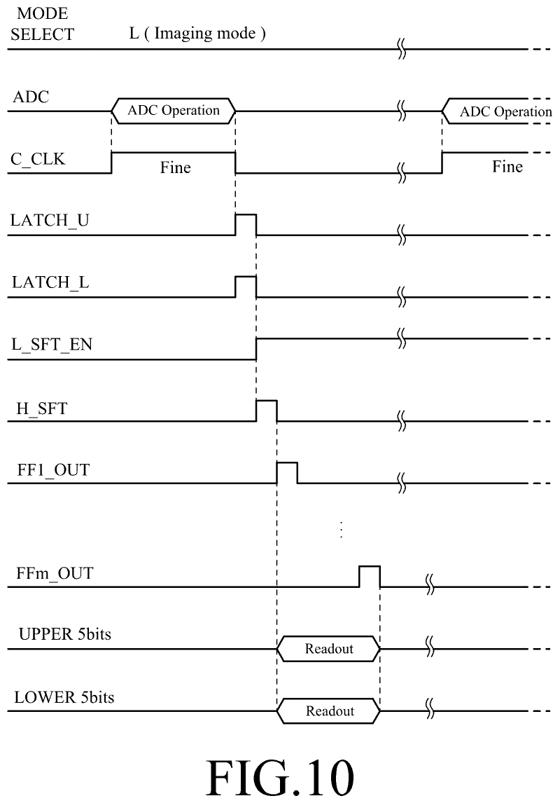

Operation timing in the imaging mode is as shown in FIG. 10. As shown in FIG. 10, in the imaging mode, when AD conversion is started, the timing controller 105 generates the clock signal C_CLK for the fine ADC, and the reference voltage generator 104 generates the first reference signal. Then, the converting section performs the fine ADC based on the clock signal C_CLK and the first reference signal.

The timing signal LATCH_U for the upper bits rises at timing when AD conversion duration for one pixel is terminated, that is, timing when AD conversion for a pixel signal read out from one pixel is completed, and the upper bits are read out from the U/D counter 802a and latched by the latch circuit 803a. Similarly, the timing signal LATCH_L for the lower bits also rises at timing when AD conversion duration for one pixel is terminated, that is, timing when AD conversion for a pixel signal read out from one pixel is completed, and the lower bits are read out from the U/D counter 802a and latched by the latch circuit 804a.

The shift register signal H_SFT for horizontal reading rises at falling timing of the timing signal LATCH_U for the upper bits. The output signal FF1_OUT from the FF1 rises at falling timing of the shift register signal H_SFT. The upper bits are read out from the buffer 805a in response to rising of the output signal FF1_OUT from the FF1. Similarly, the upper bits are sequentially read out from buffers other than the buffer 805a in response to rising of the output signals FF2_OUT, . . . , FFm_OUT from FF2, . . . , FFm respectively.

The shift register enable signal L_SFT_EN for the lower bits rises at falling timing of the timing signal LATCH_L for the lower bits. After that, the shift register enable signal L_SFT_EN for the lower bits is at High level, so that output from the AND circuit 807a is the same as the output signal FF1_OUT from the FF1. Similar to reading operation of the upper bits, the lower bits are read out from the buffer 806a in response to rising of the output signal FF1_OUT from the FF1. Similarly, the lower bits are sequentially read out from corresponding buffers other than the buffer 806a in response to rising of the output signals FF2_OUT, . . . , FFm_OUT from FF2, . . . , FFm respectively.

Configuration and operations of the converting section according to the exemplary implementation 1B have been described with respect to only the components corresponding to the vertical signal line Y1, but the same applies to components corresponding to the vertical signal lines Y2, . . . , Ym. Therefore, redundant description is omitted herein.

### Exemplary Implementation 1C

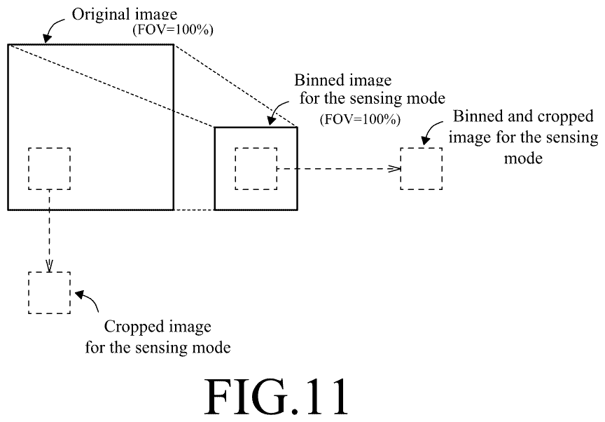

The following describes exemplary implementation 1C according to the first embodiment of the present disclosure with reference to FIG. 11.

The foregoing description has been given on assumption that pixel signals are read out from all pixels of the pixel array 101, but the sensing processing may utilize cropped, binned, or binned cropped images rather than full-sized images, as shown in FIG. 11.

Cropping is a method of reading out pixel signals from pixels in a partial area of the pixel array 101 to generate an image. When the cropping is utilized in the sensing mode, the number of pixels to be subjected to AD conversion is reduced, so that processing load and power consumption are reduced. Further, processing speed is improved and the sensing frame can be obtained in a shorter time.

Binning is a method in which a plurality of adjacent pixels of the pixel array 101 are collectively regarded as one extended pixel, and pixel signals from the plurality of pixels are read out and combined the pixel signals into one pixel signal from the extended pixel.

A pixel signal read from one of the plurality of pixels may be used as the one pixel signal from the extension pixel. When the binning is utilized in the sensing mode, the number of pixels to be subjected to AD conversion is reduced, so that processing load and power consumption are reduced. Further, processing speed is improved and the sensing frame can be obtained in a shorter time.

A field of view (FOV) remains 100% even after the binning. Therefore, a combination of the binning and the cropping may be utilized in the sensing mode. In this combination method, an image is generated by reading out pixel signals from a partial area of an extended pixel array expressed as a set of the extended pixels by the binning. When the combination method is utilized in the sensing mode, the number of pixels to be subjected to AD conversion is further reduced, so that processing load and power consumption are further reduced.

Whether or not to utilize any one of three methods above (that is, the cropping, the binning and the combination thereof) or which method to utilize may be determined based on requirements for implementation, such as a type of the sensing processing and/or an acceptable time range for generating the sensing frame. The methods of the exemplary implementation 1C are applicable to any of the first embodiment and the exemplary implementations thereof. In addition, the method of the exemplary implementation 1C are also applicable to any of the second embodiment below and the exemplary implementations thereof.

### 2. Second Embodiment

The following describes a second embodiment of the present disclosure. The second embodiment of the present disclosure relates to an AD conversion method and an image sensor, in particular, relates to an imaging module that is equipped with an image sensor having a two-stages SS-ADC capability. The imaging module according to the second embodiment has a function of switching between the imaging mode and the sensing mode, similar to the imaging module according to the first embodiment. The imaging module according to the second embodiment is configured to perform AD conversion in the two-stage SS-ADC manner in the imaging mode, and perform the coarse ADC in the sensing mode.

When detecting the signal component in the imaging mode, in the first stage, the imaging module according to the second embodiment performs AD conversion using the reference voltage signal V_REF for the coarse ADC (that is, the second reference signal), and in the second stage, performs AD conversion using the reference voltage signal V_REF for the fine ADC (that is, the first reference signal). In the second stage, a second pixel value is determined with higher precision using the first reference signal with a smaller step width, within a predetermined value range around a first pixel value that corresponds to the count number determined in the first stage. The first pixel value includes only upper bits and the second pixel value includes both upper bits and lower bits. In the sensing mode, operations of the imaging module according to the second embodiment are substantially the same as those according to the first embodiment or the exemplary implementations thereof. Therefore, redundant description is omitted herein.

### Configuration of the Imaging Module

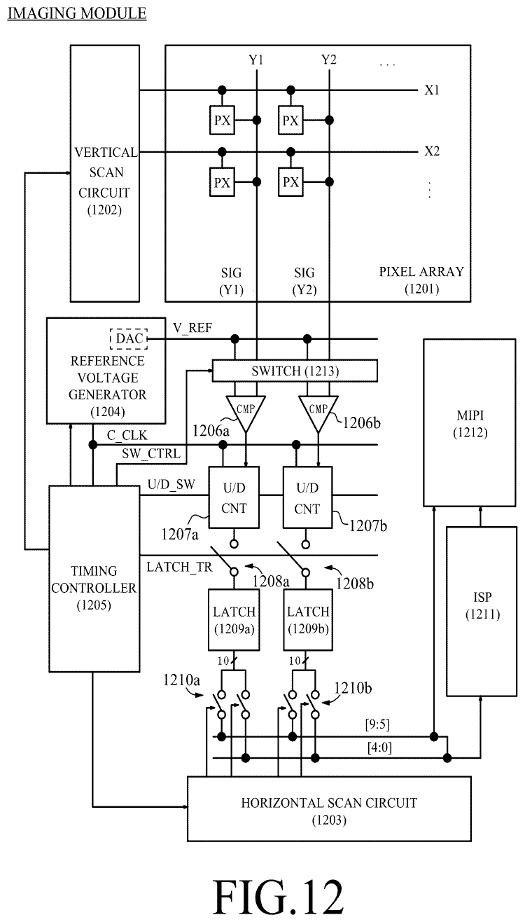

With reference to FIG. 12, the following further describes the imaging module according to the second embodiment of the present disclosure. As shown in FIG. 12, the imaging module according to the second embodiment includes a pixel array 1201, a vertical scan circuit 1202, a horizontal scan circuit 1203, a reference voltage generator 1204 and a timing controller 1205. In FIG. 12, the horizontal signal lines X3, . . . , Xn and the vertical signal lines Y3, . . . , Ym are omitted for simplicity. Further, comparators, U/D counters, switches, latch circuits and switch pairs corresponding to the vertical signal lines Y3, . . . , Ym are also omitted for simplicity. It should be understood that the components corresponding to the vertical signal lines Y1, . . . , Ym have substantially the same configuration as each other. Thus, the following may focus on components corresponding to the vertical signal lines Y1 and Y2, and description of components corresponding to the vertical signal lines Y3, . . . , Ym may be omitted for ease of description. For the components corresponding to the vertical signal lines Y3, . . . , Ym, refer to description of the components corresponding to the vertical signal lines Y1 and Y2.

The imaging module according to the second embodiment further includes comparators (CMP) 1206a and 1206b, U/D counters (U/D CNT) 1207a and 1207b, switches 1208a and 1208b, latch circuits (LATCH) 1209a and 1209b, and switch pairs 1210a and 1210b. The imaging module according to the second embodiment further includes an ISP 1211, a MIPI 1212 and a stage switching section 1213.

Functionality and operations of the pixel array 1201, the vertical scan circuit 1202, the horizontal scan circuit 1203, the reference voltage generator 1204 and the timing controller 1205 are substantially the same as those of the pixel array 101, the vertical scan circuit 102, the horizontal scan circuit 103, the reference voltage generator 104 and the timing controller 105 shown in FIG. 2, respectively. Also, functionality functions and operations of the comparators 1206a and 1206b, the U/D counters 1207a and 1207b, the switches 1208a and 1208b, the latch circuits 1209a and 1209b and the switch pairs 1210a and 1210b are substantially the same as those of the comparators 106a and 106b, the U/D counters 107a and 107b, the switches 108a and 108b, the latch circuits 109a and 109b and switch pairs 110a and 110b shown in FIG. 2, respectively. Also, functionality and operations of the image signal processor 1211 and the mobile industry processor interface 1212 are substantially the same as those of the image signal processor 111 and the mobile industry processor interface 112 shown in FIG. 2, respectively. Therefore, redundant description is omitted herein.

As mentioned above, the imaging module according to the second embodiment includes the stage switching section 1213. The stage switching section 1213 is configured to switch between the first stage and the second stage in the time period TP_SIG for reading out the signal component of the pixel signal in the imaging mode. Operations of the stage switching section 1213 is controlled by a switching control signal SW_CTRL supplied from the timing controller 1205. In the sensing mode, the stage switching section 1213 does not perform operations for switching between the first stage and the second stage, that is, the imaging module according to the second embodiment performs substantially the same operations as those according to the first embodiment.

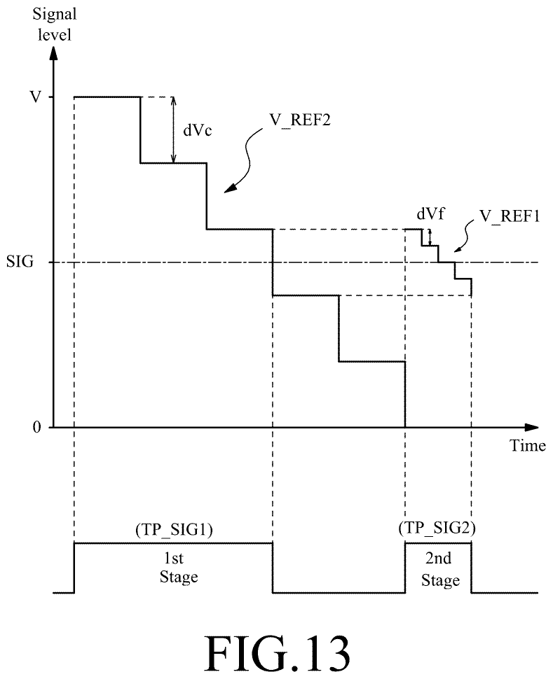

With reference to FIG. 13, the following describes switching operations between the first stage and the second stage. FIG. 13 shows a first reference signal V_REF1, a second reference signal V_REF2 and a signal level SIG of the pixel signal. The second reference signal V_REF2 is the same as the second reference signal in the first embodiment. The first reference signal V_REF1 is the same as the first reference signal in the first embodiment, or the first reference signal V_REF1 is another ramp signal having a smaller step width than the second reference signal V_REF2. In the example of FIG. 13, a step width of the second reference signal V_REF2 is dVc, and a step width of the first reference signal V_REF1 is dVf, where dVf<dVc.

In the first stage, the imaging module compares the second reference signal V_REF2 and the pixel signal SIG, similar to the coarse ADC in the first embodiment, and increments a value of the counter by 1 at rising timing of the clock signal C_CLK corresponding to the second reference signal V_REF2 when the pixel signal SIG is greater than the second reference signal V_REF2. In the second stage, the imaging module compares the pixel signal SIG with the first reference signal V_REF1 having the step width dVf, within the step width dVc of a step crossing the pixel signal SIG in the first stage, and increments the value of the counter by 1 at rising timing of the clock signal C_CLK corresponding to the first reference signal V_REF1 when the pixel signal SIG is greater than the first reference signal V_REF1.

When the comparison between the second reference signal V_REF2 and the pixel signal SIG is completed in the first stage and the value of the counter is obtained, the stage switching section 1213 switches from the first stage to the second stage. At this time, the stage switching section 1213 sets an initial voltage of the first reference signal V_REF1 used in the second stage based on the value of the counter obtained in the first stage, and supplies the first reference signal V_REF1 to the comparators 1206a and 1206b. In the example of FIG. 13, the initial voltage of the first reference signal V_REF1 is (V−2×dVc). In a time period TP_SIG2 of the second stage, the clock signal C_CLK with the pulse width PW1 that corresponds to the first reference signal V_REF1 is supplied from the timing controller 105 to the comparators 1206a and 1206b.

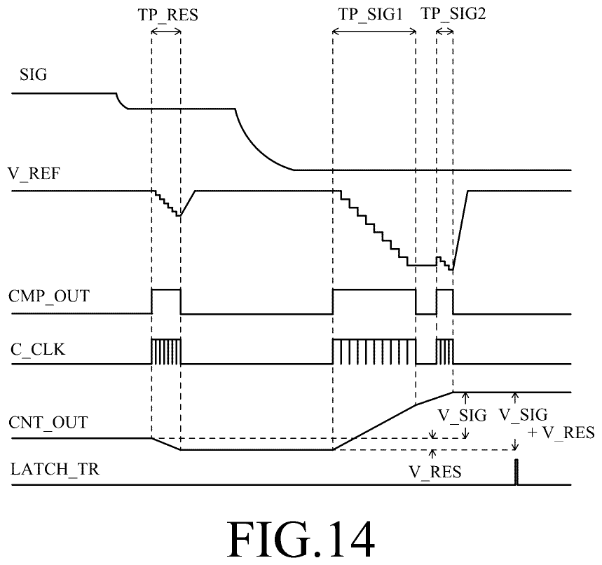

In the example shown in FIG. 14, the two-stage AD conversion described above is not performed during the time period TP_RES for reading out the reset component. Operations of the imaging module during the time period TP_RES for reading out the reset component are substantially the same as operations of the imaging module according to the first embodiment described with reference to FIG. 4. Therefore, redundant description is omitted herein. Optionally, the operations of the imaging module during the time period TP_RES for reading out the reset component may be substantially the same as operations of the imaging module according to the exemplary implementation 1A of the first embodiment described with reference to FIG. 7. Such variation also belongs to a technical scope of the second embodiment.

As described above, in the second embodiment of the present disclosure, in the imaging mode, the coarse ADC is implemented in the first stage, and AD conversion with higher ADC resolution is implemented in the second stage while limiting a range of values to search the pixel value. In this way, the second embodiment employs the two-stage SS-ADC manner in the imaging mode, thereby reducing processing load and power consumption.

### Exemplary Implementation 2A

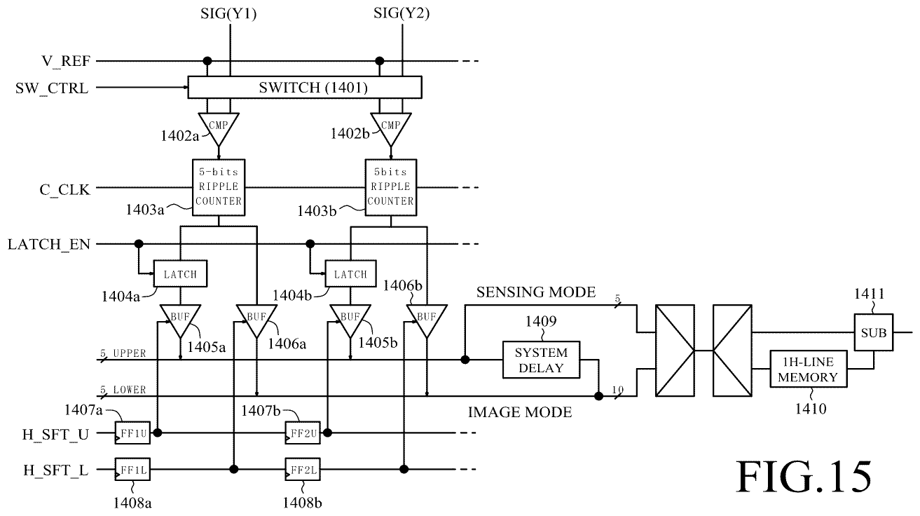

The following describes exemplary implementation 2A according to the second embodiment of the present disclosure with reference to FIG. 15.

FIG. 15 shows an example in which the converting section is implemented using asynchronous ripple counters. For simplicity of description, components corresponding to the vertical signal lines Y3, . . . , Ym are omitted. Functionality and operations of the stage switching section 1401 and comparators 1402a and 1402b shown in FIG. 15 are substantially the same as those of the stage switching section 1213 and the comparators 1206a and 1206b shown in FIG. 12. Therefore, redundant description is omitted herein. It should be understood that the components corresponding to the vertical signal lines Y1, . . . , Ym have substantially the same configuration as each other. Thus, the following may focus on components corresponding to the vertical signal lines Y1 and Y2, and description of components corresponding to the vertical signal lines Y3, . . . , Ym may be omitted for ease of description. For the components corresponding to the vertical signal lines Y3, . . . , Ym, refer to description of the components corresponding to the vertical signal lines Y1 and Y2. For ease of description, it is assumed that ADC resolution in the imaging mode is 10 bits and ADC resolution in the sensing mode is 5 bits.

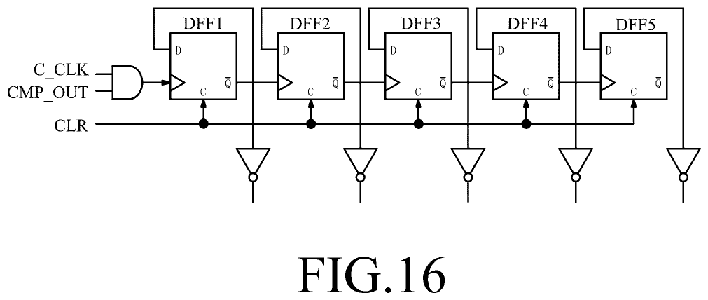

As shown in FIG. 15, an output signal CMP_OUT of the comparator 1402a is supplied to a ripple counter 1403a. The clock signal C_CLK is supplied from the timing controller 105 to the ripple counter 1403a. The ripple counter 1403a may be implemented for example by serially connecting five D-type flip-flops (DFFs), as shown in FIG. 16. CLR in FIG. 16 is a clear signal. Ripple counters other than the ripple counter 1403a may also be implemented with circuit configuration shown in FIG. 16.

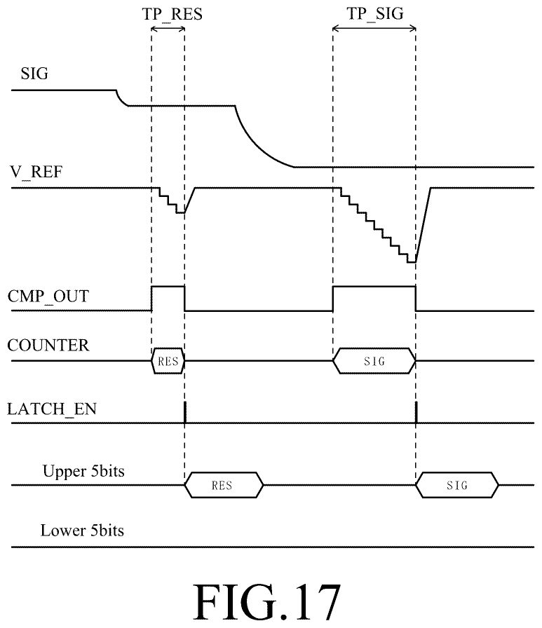

A latch enable signal LATCH_EN is supplied from the timing controller 1205 to the latch circuit 1404a. As shown in FIG. 17, the latch enable signal LATCH_EN rises at timing when each of the time period TP_RES for reading out the reset component and the time period TP_SIG for reading out the signal component is terminated. The latch circuit 1404a latches a counter value from the ripple counter 1403a at rising timing of the latch enable signal LATCH_EN, and outputs the counter value to a buffer 1405a. The counter value of the ripple counter 1403a is also output to a buffer 1406a.

The ripple counter 1403a is cleared by a horizontal shift register signal H_SFT_U for upper bits of the pixel value. A horizontal shift register signal H_SFT_U for upper bits of the pixel value is supplied to a flip-flop 1407a (FF1U). An output signal FF1U_OUT from the FF1U is supplied to the buffer 1405a. The buffer 1405a outputs the counter value stored therein to the first output signal line for the upper bits at rising timing of the output signal FF1U_OUT. The counter value stored in the buffer 1405a corresponds to the upper 5-bits of the pixel value.

A horizontal shift register signal H_SFT_L for lower bits of the pixel value is supplied to a flip-flop 1408a (FF1L). An output signal FF1L_OUT from the FF1L is supplied to the buffer 1406a. In the sensing mode, the horizontal shift register signal H_SFT_L for lower bits is maintained at Low level, so that no signal is output to the second output signal line. In the imaging mode, the buffer 1406a outputs the counter value stored therein to the second output signal line for the lower bits at rising timing of the output signal FF1L_OUT. The counter value stored in the buffer 1406a corresponds to the lower 5-bits of the pixel value.

As described above, the asynchronous ripple counters are used in the exemplary implementation 2A, so that a difference may occur in the imaging mode between output timing of the upper bits and output timing of the lower bits. However, in the exemplary implementation 2A, subtraction of the timing difference and the reset value corresponding to the reset component of the pixel signal is performed using a system delay section 1409, a one-horizontal line memory 1410 and a subtractor 1411 shown in FIG. 15.

### Exemplary Implementation 2B

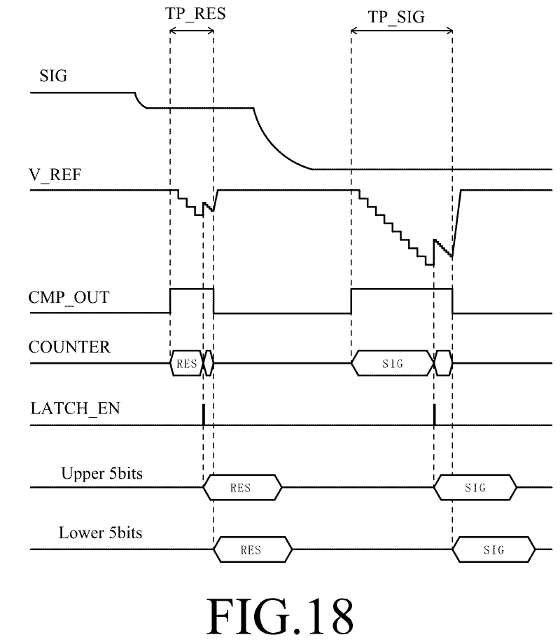

The following describes exemplary implementation 2B according to the second embodiment of the present disclosure with reference to FIG. 18. The exemplary implementation 2B proposes a method of performing the two-stage SS-ADC during both the time period TP_RES for reading out the reset component and the time period TP_SIG for reading out the signal component. Operations of the converting section during the time period TP_SIG for reading out the signal component is substantially the same as that of the two-stage SS-ADC described with reference to FIG. 13. Operations of the converting section during the time period TP_RES for reading out the reset component is substantially the same as that of the two-stage SS-ADC described with reference to FIG. 13, except that each counter is set to the down-count mode.

As shown in FIG. 18, in the time period TP_RES for reading out the reset component, upper 5 bits of the reset component are obtained in the first stage, and lower 5 bits of the reset component are obtained in the second stage. In the time period TP_SIG for reading out the signal component, upper 5 bits of the signal component are obtained in the first stage, and lower 5 bits of the signal component are obtained in the second stage. Optionally, the two-stage SS-ADC may be applied to AD conversion of the reset component when the reset component is relatively large.

### 3. Configuration of Electronic Device

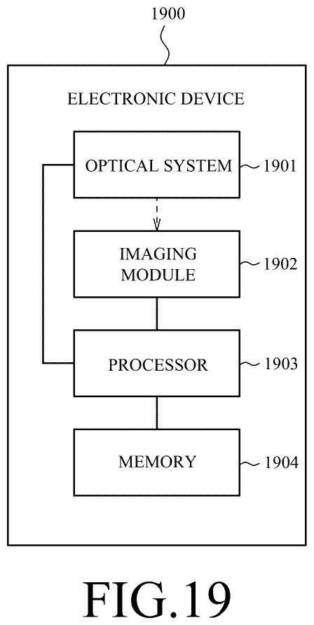

The following describes an electronic device to which the imaging module of the present disclosure can be applied, with reference to FIG. 19. The electronic device may be, for example, a smartphone, a cellular phone, a tablet computer, a personal computer, a digital still camera, a digital video camera, a vehicle camera, a surveillance camera, a security camera, a web camera, an intercom, or the like. Of course, embodiments of the present disclosure are not limited to these examples.

An electronic device 1900 shown in FIG. 19 is one example of the electronic device to which the imaging module of the present disclosure can be applied. The electronic device 1900 includes an optical system 1901, an imaging module 1902, a processor 1903 and a memory 1904.

The optical system 1901 includes one or more lens groups each including one or more lenses, one or more optical filters, an aperture mechanism, a driving circuit for moving the one or more lenses or the lens groups, and the like.

The imaging module 1902 is the imaging module according to any one of the first embodiment, the exemplary implementations of the first embodiment, the second embodiment and the exemplary implementations of the second embodiment described above.

Light enters the imaging module 1902 via the optical system 1901 and is received by each pixel of the imaging module 1902. The imaging module 1902 converts a pixel signal from each pixel into a pixel value to generate image data. In the imaging mode, the image data correspond to an image frame. In the sensing mode, the image data correspond to a sensing frame. The image data is output to the processor 1903.

When the image data correspond to the sensing frame, the processor 1903 executes the sensing processing using the image data, and then reflects result of the sensing processing in imaging operations of the image frame. The sensing processing is object detection or phase difference detection AF based on AI processing such as a deep neural network (e.g., a binary neural network, a ternary neural network or the like). In an example, the processor 1903 utilizes the sensing frame to detect an object and controls driving circuitry of the optical system 1901 to focus on the detected object. The object may be a person or people, one or more animals, one or more faces, one or more eyes, one or more vehicles, or the like.

The processor 1903 may be an integrated circuit chip, and has a signal processing capability. In an implementation process, steps such as processing image data from the image sensor, encoding or decoding processing and/or storing the processed data into the memory 1904 can be implemented by using a hardware integrated logical circuit in the processor 1903 or by using instructions in a form of software.

The processor 1903 may be a general-purpose processor, a digital signal processor (DSP), an application-specific integrated circuit (ASIC), a field-programmable gate array (FPGA) or another programmable logic device, a discrete gate or a transistor logic device, or a discrete hardware component. It may implement or perform the steps, and logical block diagrams that are disclosed in embodiments of this disclosure. The general-purpose processor may be a microprocessor, or the processor 1903 may be any processor or the like. Some steps may be directly executed and accomplished by using a hardware coding processor, or may be executed and accomplished by using a combination of hardware and software modules in the coding processor. A software module may be located in a mature storage medium in the art, such as a random-access memory (RAM), a flash memory, a read-only memory (ROM), a programmable ROM (PROM), an electrically erasable programmable memory, or a register. The storage medium is located in the memory 1904, and the processor 1903 reads information in the memory 1904 and completes the steps in combination with hardware of the processor 1903.

The memory 1904 may be a volatile memory or a nonvolatile memory, or may include a volatile memory and a nonvolatile memory. The nonvolatile memory may be a ROM, a PROM, an erasable PROM (EPROM), an electrically EPROM (EEPROM), or a flash memory. The volatile memory may be a RAM, used as an external cache. Through example but not limitative description, many forms of RAMs may be used, for example, astatic RAM (SRAM), adynamic RAM (DRAM), a synchronous DRAM (SDRAM), a double data rate (DDR) SDRAM, an enhanced SDRAM (ESDRAM), a synchronous-link DRAM (SLDRAM), and a direct Rambus (DR) RAM. It should be noted that the memory 1904 described in this specification includes but is not limited to these and any memory of another proper type.

### 4. Operations of Imaging Module

### AD Conversion

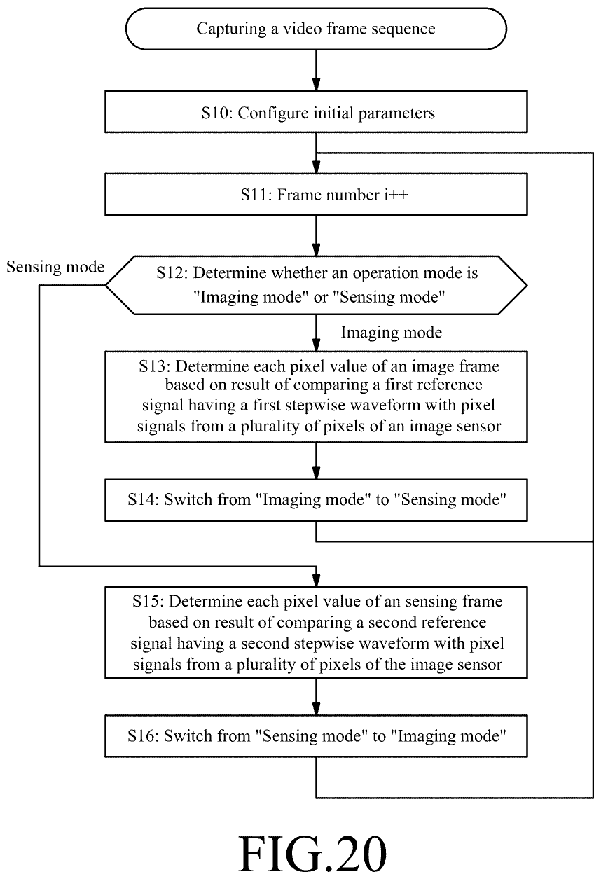

The following describes an AD conversion method by the imaging module according to the embodiments of the present disclosure, with reference to FIG. 20. Each step shown in FIG. 20 is performed by the imaging module according to any one of the embodiments described above. For ease of description, an exemplary case that a video frame sequence including N frames is obtained is described below.
Step S10: Configure initial parameters. In this example, an index i indicating a frame number is set to an initial value 0, an initial operation mode is set to “Imaging mode” for generating an image frame. Optionally, the initial operation mode may be set to “Sensing mode” for generating a sensing frame used to obtain information usable when capturing the image frame.
Step S11: Increment the index i indicating the frame number. If the process proceeds to Step S11 and the index i is N, a sequence of the processes shown in FIG. 20 would be terminated.
Step S12: Determine whether the operation mode is “Imaging mode” or “Sensing mode”. When the operation mode is “Imaging mode”, the process proceeds to Step S13. When the operation mode is “Sensing mode”, the process proceeds to Step S15.
Step S13: Determine each pixel value of the image frame based on result of comparing a first reference signal having a first stepwise waveform with pixel signals from a plurality of pixels of an image sensor. For example, the imaging module determines a pixel value corresponding to a signal component of each pixel signal, using the method shown in FIG. 3. Each of determined pixel values is output as image data of the image frame.
Step S14: Switch from “Imaging mode” to “Sensing mode”. After the process of Step S14 is completed, the process proceeds to Step S11.
Step S15: Determine each pixel value of the sensing frame based on result of comparing a second reference signal having a second stepwise waveform with pixel signals from the plurality of pixels of the image sensor. The second stepwise waveform has a larger step width than that of the first stepwise waveform. In an example, the imaging module determines a pixel value corresponding to a signal component of each pixel signal, using the method according to the first embodiment shown in FIG. 4. In another example, the imaging module determines a pixel value corresponding to a signal component of each pixel signal, using the method according to the exemplary implementations of the first embodiment shown in FIG. 7. In yet another example, the imaging module determines a pixel value corresponding to a signal component of each pixel signal, using the method according to the second embodiment shown in FIG. 14. Each of determined pixel values is output as image data of the sensing frame.
Step S16: Switch from “Sensing mode” to “Imaging mode”. After the process of Step S16 is completed, the process proceeds to Step S11.

In the example shown in FIG. 20, switching between the imaging mode for generating the image frame and the sensing mode for generating the sensing frame is performed for every frame. In the imaging mode, AD conversion is performed at high ADC resolution, that is, the fine ADC is performed in the imaging mode, so that the high-quality image frame is obtained. In the sensing mode, AD conversion is performed at low ADC resolution, that is, the coarse ADC is performed in the sensing mode, so that time required for the AD conversion is shorten. This can prevent from delay in starting the sensing processing, so that result of the sensing processing can be utilized in a subsequent imaging operation of an image frame without significant delay.

### Optical Black Level Adjustments

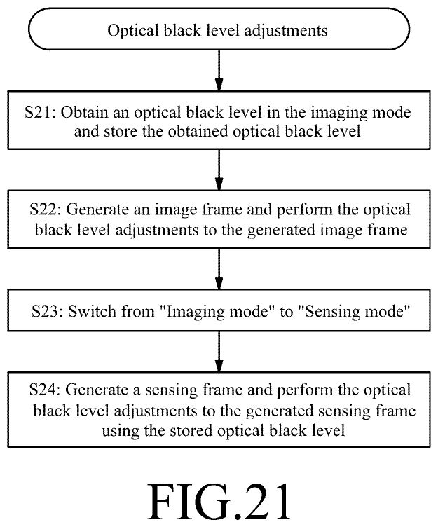

The following describes a procedure of an optical black level adjustments by the imaging module according to the embodiments of the present disclosure, with reference to FIG. 21. Each step in FIG. 21 may be performed by the imaging module according to any one of the embodiments described above. For ease of description, an exemplary case in which the optical black level adjustments are applied to one image frame and one sensing frame following the image frame. Practically, the optical black level adjustments may be performed in the same way for all frames in the frame sequence.
Step S21: Obtain an optical black level in the imaging mode and store the obtained optical black level. The imaging module performs, in the imaging mode, AD conversion for pixel signals from a first area that is formed by OB pixels used for the optical black level adjustments. Then, the imaging module obtains an optical black level based on pixel values of the OB pixels, and stores the obtained optical black level therein.
Step S22: Generate an image frame and perform the optical black level adjustments to the generated image frame. The imaging module performs the AD conversion for pixel signals from a second area different from the first area, to generate the image frame. Then, the imaging module performs the optical black level adjustments to the generated image frame using the optical black level obtained at Step S21.
Step S23: Switch from “Imaging mode” to “Sensing mode”.
Step S24: Generate a sensing frame and perform the optical black level adjustments to the generated sensing frame using the stored optical black level. The imaging module performs AD conversion for pixel signals from the second area to generate the sensing frame, without AD conversion for pixel signals from the first area. Then, the imaging module performs the optical black level adjustments to the generated sensing frame using the optical black level obtained at Step S21.

In the example shown in FIG. 21, AD conversion for pixel signals from OB pixels is omitted in the sensing mode. Since the OB pixels lack useful information for the sensing processing, even if the AD conversion of pixel signals from the OB pixels is omitted, it scarcely affects the results of the sensing processing. In addition, omitting the AD conversion for the first area having the OB pixels makes it possible to shorten the time required for the AD conversion in the sensing mode. Further, the number of to-be-processed pixel signals is reduced, so that power consumption of the image sensor is also reduced. According to the method shown in FIG. 21, the imaging module can perform the optical black level adjustments to the sensing frame using the optical black level obtained in the imaging mode. The optical black level adjustments may improve image quality of the sensing frame, thereby improve precision of the sensing processing.

A person of ordinary skill in the art may be aware that, in combination with the examples described in embodiments disclosed in this specification, units and steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

In the embodiments provided in this disclosure, it should be noted that the disclosed module, apparatus and method may be implemented in other manners. For example, a plurality of components may be combined or integrated into another unit, or some features may be ignored or not performed. In addition, the displayed or discussed mutual couplings or direct couplings may be implemented by using some interfaces. The indirect couplings or connections between the components may be implemented in electronic, mechanical or other forms. Some or all of the components may be selected based on actual requirements to achieve objectives of solutions of the embodiments. In addition, each of the components may exist alone physically, or two or more components are physically integrated into one unit.

The foregoing are merely implementations of this disclosure, but are not intended to limit a protection scope of this disclosure. Any variation or replacement readily figured out by a person skilled in the art within the technical scope disclosed in this disclosure shall fall within the protection scope of this disclosure. Hence, the protection scope of this disclosure shall be subject to the protection scope of the claims.

What is claimed is:

1. A method comprising:
switching between an imaging mode for generating an image frame and a sensing mode for generating a sensing frame, wherein the sensing frame is for obtaining information available when capturing the image frame;
generating a first reference signal having a first stepwise waveform and a second reference signal having a second stepwise waveform, wherein a second step width of the second stepwise waveform is greater than a first step width of the first stepwise waveform;
determining, in the imaging mode, first pixel values of the image frame by comparing the first reference signal with first pixel signals from first pixels of an image sensor, or determining, in the sensing mode, second pixel values of the sensing frame by comparing the second reference signal with the first pixel signals; and
outputting the first pixel values as first image data of the image frame, or outputting the second pixel values as second image data of the sensing frame.

2. The method of claim 1, wherein switching between the imaging mode and the sensing mode comprises switching between the imaging mode and the sensing mode for every frame in a video frame sequence.

3. The method of claim 1, wherein determining, in the sensing mode, the second pixel values comprises determining the second pixel values by comparing the second reference signal with second pixel signals from second pixels in a second area of the sensing frame, wherein the second area is different from a first area of the sensing frame, and wherein the first area includes third pixels for optical black level adjustments.

4. The method of claim 3, further comprising:
obtaining and storing an optical black level in the imaging mode; and
adjusting the sensing frame to have the optical black level.

5. The method of claim 1, wherein determining, in the sensing mode, the second pixel values comprises determining the second pixel values by comparing second pixel signals from a portion of the first pixels with the second reference signal.

6. The method of claim 1, wherein determining, in the sensing mode, the second pixel values comprises:
obtaining, using the first reference signal, reset values corresponding to reset components of second pixel signals of the sensing frame; and
determining, using the second reference signal and based on the reset values, signal values as third pixel values corresponding to the second pixel signals, wherein the signal values correspond to remaining components of the second pixel signals after eliminating the reset components from the second pixel signals.

7. The method of claim 1, wherein determining, in the imaging mode, the first pixel values comprises:
obtaining, using the first reference signal, reset values corresponding to reset components of second pixel signals of the sensing frame;
determining, using the second reference signal and based on the reset values, first signal values corresponding to remaining components of the second pixel signals after eliminating the reset components from the second pixel signals; and
determining, using the first reference signal and within a preset value range of the first signal values, second signal values corresponding to the remaining components as third pixel values corresponding to the second pixel signals, wherein the second signal values have a higher precision than the first signal values.

8. An image sensor comprising:
a timing controller configured to switch between an imaging mode for generating an image frame and a sensing mode for generating a sensing frame, wherein the sensing frame is for obtaining information available when capturing the image frame;
a reference signal generator configured to generate a first reference signal having a first stepwise waveform and a second reference signal having a second stepwise waveform, wherein a second step width of the second stepwise waveform is greater than a first step width of the first stepwise waveform; and
a converter configured to:
determine, in the imaging mode, first pixel values of the image frame by comparing the first reference signal with first pixel signals from first pixels, or determine, in the sensing mode, second pixel values of the sensing frame by comparing the second reference signal with the first pixel signals; and
output the first pixel values as first image data of the image frame, or outputting the second pixel values as second image data of the sensing frame.

9. The image sensor of claim 8, wherein the timing controller is further configured to further switch between the imaging mode and the sensing mode by switching between the imaging mode and the sensing mode for every frame in a video frame sequence.

10. The image sensor of claim 8, wherein the converting section is further configured to further determine, in the sensing mode, the second pixel values by determining the second pixel values by comparing the second reference signal with second pixel signals from second pixels in a second area of the sensing frame, wherein the second area is different from a first area of the sensing frame, and wherein the first area includes third pixels for optical black level adjustments.

11. The image sensor of claim 10, further comprising a processor configured to:
obtain and store an optical black level in the imaging mode; and
adjust the sensing frame to have the optical black level.

12. The image sensor of claim 8, wherein the converting section is further configured to further determine the second pixel values by determining the second pixel values by comparing second pixel signals from a portion of the first pixels with the second reference signal.

13. The image sensor of claim 8, wherein the converter is further configured to further determine, in the sensing mode, the second pixel values by:
obtaining, using the first reference signal, reset values corresponding to reset components of second pixel signals of the sensing frame; and
determining, using the second reference signal and based on the reset values, signal values as third pixel values corresponding to the second pixel signals, wherein the signal values correspond to remaining components of the second pixel signals after eliminating the reset components from the second pixel signals.

14. A computer program product comprising a computer program that, when executed by a processor, cause an electronic device to:
switch between an imaging mode for generating an image frame and a sensing mode for generating a sensing frame, wherein the sensing frame is for obtaining information available when capturing the image frame;
generate a first reference signal having a first stepwise waveform and a second reference signal having a second stepwise waveform, wherein a second step width of the second stepwise waveform is greater than a first step width of the first stepwise waveform;
determine, in the imaging mode, first pixel values of the image frame by comparing the first reference signal with first pixel signals from first pixels of an image sensor, or determine, in the sensing mode, second pixel values of the sensing frame by comparing the second reference signal with the first pixel signals; and
output the first pixel values as first image data of the image frame, or outputting the second pixel values as second image data of the sensing frame.

15. The computer program product of claim 14, wherein the computer program, when executed by the processor, further causes the electronic device to further switch between the imaging mode and the sensing mode by switching between the imaging mode and the sensing mode for every frame in a video frame sequence.

16. The computer program product of claim 14, wherein the computer program, when executed by the processor, further causes the electronic device to further determine, in the sensing mode, the second pixel values by determining the second pixel values by comparing the second reference signal with second pixel signals from second pixels in a second area of the sensing frame, wherein the second area is different from a first area of the sensing frame, and wherein the first area includes third pixels for optical black level adjustments.

17. The computer program product of claim 16, wherein the computer program, when executed by the processor, further causes the electronic device to:
obtain and store an optical black level in the imaging mode; and
adjust the sensing frame to have the optical black level.

18. The computer program product of claim 14, wherein the computer program, when executed by the processor, is further causes the electronic device to further determine the second pixel values by determining the second pixel values by comparing second pixel signals from a portion of the first pixels with the second reference signal.

19. The computer program product of claim 14, wherein the computer program, when executed by the processor, is further configured to cause the electronic device to further determine, in the sensing mode, the second pixel values by:
obtaining, using the first reference signal, reset values corresponding to reset components of second pixel signals of the sensing frame; and
determining, using the second reference signal and based on the reset values, signal values as third pixel values corresponding to the second pixel signals, wherein the signal values correspond to remaining components of the second pixel signals after eliminating the reset components from the second pixel signals.

20. The computer program product of claim 14, wherein the computer program, when executed by the processor, is further configured to cause the electronic device to further determine, in the imaging mode, the first pixel values by:
obtaining, using the first reference signal, reset values corresponding to reset components of second pixel signals of the sensing frame;
determining, using the second reference signal and based on the reset values, first signal values corresponding to remaining components of the second pixel signals after eliminating the reset components from the second pixel signals; and
determining, using the first reference signal and within a preset value range of the first signal values, second signal values corresponding to the remaining components as third pixel values corresponding to the second pixel signals, wherein the second signal values have a higher precision than the first signal values.
